(19) United States
(12) Patent Application Publication
(10) Pub. No.: US 2012/0063440 A1
(43) Pub. Date: Mar. 15, 2012

(54) WIRELESS LAN ACCESS POINT DEVICE, MOBILE COMMUNICATION TERMINAL, COMMUNICATION METHOD, AND PROGRAM

(76) Inventor: Takahiro Seo, Tokyo (JP)

(21) Appl. No.: 13/322,409

(22) PCT Filed: May 26, 2010
(86) PCT No.: PCT/JP2010/058895

§ 371 Date: Nov. 23, 2011

(30) Foreign Application Priority Data
May 27, 2009 (JP) 2009-128035

(51) Int. Cl. H04W 88/08

(52) U.S. Cl. 370/338

(57) ABSTRACT

A wireless LAN access point device, wherein when the wireless LAN access point device receives from a wireless LAN (Local Area Network) client(s) being subordinate to the wireless LAN access point device a request for connection to a predetermined server, the wireless LAN access point device respectively establishes separate communication connections with a side of the wireless LAN client(s) and with a side of the predetermined server, and performs transmission/reception control over data to be transmitted to and received from the wireless LAN client(s) and the predetermined server.

### DESCRIPTION OF RELATED APPLICATION

The present invention is based upon and claims the benefit of the priority of Japanese Patent Application No. 2009-128035 (filed on May 27, 2009), the disclosure of which is incorporated herein in its entirety by reference.

### TECHNICAL FIELD

The present invention relates to a wireless LAN (Local Area Network) access point device, a mobile communication terminal, a communication method, and a program.

### BACKGROUND ART

Patent Document 1 discloses cellular phones each including a wireless LAN access point function. Patent Document 2 discloses a cellular phone that functions as a wireless LAN access point in a state where the cellular phone is placed on a cradle. When these devices capable of operating as wireless LAN master devices are employed, it is possible to make connection to the Internet even at a location at which there is no wired Internet environment but which can be connected to a mobile communication network.

### RELATED ART DOCUMENT

### Patent Document

### [Patent Document 1]

JP Patent Kokai Publication No. JP2006-270889A

### [Patent Document 2]

JP Patent Kokai Publication No. JP2006-33368A

### SUMMARY OF THE INVENTION

### Problems to be Solved by the Invention

The entire disclosure of Patent Documents listed above is incorporated herein by reference.

Generally, it is premised that a device including a wireless LAN connection function uses a public wireless LAN access point or a wireless LAN router at home. It is not supposed that such a device performs communication via a mobile communication network. The device does not have specifications for using setting tuned for wireless communication such as W-TCP (Wireless Profiled Transport Control Protocol) or a transport layer protocol.

For this reason, a device described in each of the above-mentioned Patent Documents that uses the wireless LAN access point establishes a TCP (Transport Control Protocol) connection with a desired Web server or the like across a wireless LAN network and a mobile communication network (refer to FIG. 8). Thus, there is a problem that a retransmission request resulting from a delay or a packet loss inherent to wireless communication frequently occurs, and the throughput of the wireless LAN access point is reduced.

The cradle described in Patent Document 2 to which the cellular phone is connected, for example, relays data on a data link layer using a bridge processing function. As indicated by a protocol stack in FIG. 7 in Patent Document 2, the personal computer and the Web server directly establish the TCP connection. It is anticipated that not only when the cellular phone is used being placed on the cradle, but also when the wireless LAN function is used during movement or outside home, the throughput of the wireless LAN access point is further reduced.

The present invention has been made in view of the above-mentioned situation. It is therefore an object of the present invention to improve throughput performance of a wireless LAN access point device that provides a service via a mobile communication network.

### Means to Solve the Problems

According to a first aspect of the present invention, there is provided a wireless LAN access point device, wherein

when the wireless LAN access point device receives from a wireless LAN (Local Area Network) client(s) being subordinate to the wireless LAN access point device a request for connection to a predetermined server, the wireless LAN access point device respectively establishes separate communication connections with a side of the wireless LAN client(s) and with a side of the predetermined server, and performs transmission/reception control over data to be transmitted to and received from the wireless LAN client(s) and the predetermined server.

According to a second aspect of the present invention, there is provided a mobile communication terminal, wherein

the mobile communication terminal includes a wireless LAN (Local Area Network) access point function; and

when the mobile communication terminal receives from a wireless LAN client(s) being subordinate to the mobile communication terminal a request for connection to a predetermined server, the mobile communication terminal respectively establishes separate communication connections with a side of the wireless LAN client(s) and with a side of the predetermined sever, and performs transmission/reception control over data to be transmitted to and received from the wireless LAN client(s) and the predetermined server.

According to a third aspect of the present invention, there is provided a communication method comprising the steps of:

respectively establishing separate communication connections with a side of a wireless LAN client(s) being subordinate to the mobile communication terminal and a predetermined server when the mobile communication terminal receives from the wireless LAN client(s) a request for connection to the predetermined server, the mobile communication terminal including a wireless LAN (Local Area Network) access point function to operate as a wireless LAN access point; and

performing transmission/reception control over data to be transmitted to and received from the wireless LAN client(s) and the predetermined server.

According to a fourth aspect of the present invention, there is provided a program for a computer mounted on a mobile communication terminal that includes a wireless LAN (Local Area Network) access point function to operate as a wireless LAN access point, the program causing the computer to execute the processes of:

respectively establishing separate communication connections with a side of a wireless LAN client(s) being subordinate to the mobile communication terminal and with a side of a predetermined server when the mobile communication terminal receives from the wireless LAN client(s) a request for connection to the predetermined server; and

performing transmission/reception control over data to be transmitted to and received from the wireless LAN client(s) and the predetermined server.

### EFFECT OF THE INVENTION

According to the present invention, throughput performance of the wireless LAN access point that provides a service via a mobile communication network can be improved. The reason for this effect is that it is so configured that a communication connection with the wireless LAN client(s) is terminated at the own device side, a separate communication connection is established in a segment between the own device and the predetermined server via the mobile communication network, and transmission/reception control is performed in each segment.

### BRIEF DESCRIPTION OF THE DRAWINGS

FIG. 1 is a diagram for explaining an overview of the present invention;

FIG. 2 is a diagram for explaining a schematic configuration of a first exemplary embodiment of the present invention;

FIG. 3 is a block diagram showing a configuration of a mobile communication terminal in the first exemplary embodiment of the present invention;

FIG. 4 is a diagram showing a protocol stack when a wireless LAN client shown in FIG. 2 is accessing a contents server;

FIG. 5 is a sequence diagram showing operations until when the wireless LAN client in FIG. 2 becomes subordinate to the mobile communication terminal that operates as an access point;

FIG. 6 is a sequence diagram when the wireless LAN client in FIG. 2 has made an access request to the contents server;

FIG. 7 is a table for explaining another exemplary embodiment of the present invention; and

FIG. 8 is a diagram for explaining a TCP connection between a wireless LAN client and a contents server.

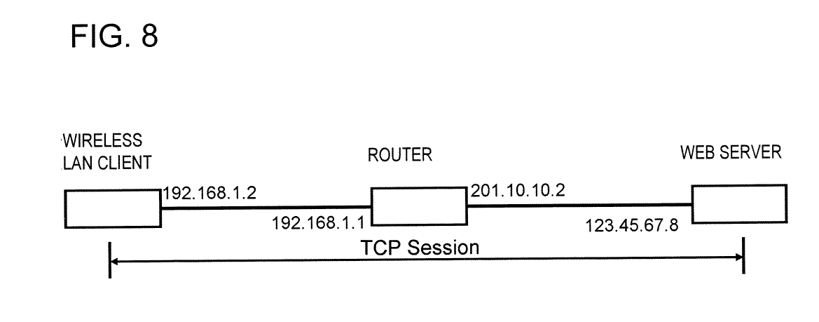

### PREFERRED MODES FOR CARRYING OUT THE INVENTION

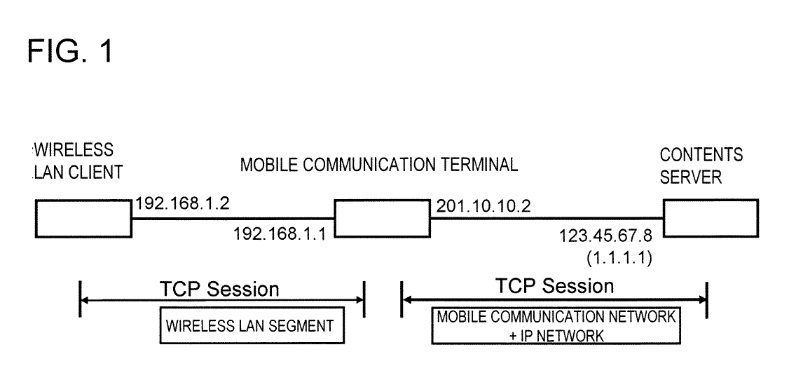

First, an overview of the present invention will be described. As shown in FIG. 1, when a wireless LAN access point device (wireless LAN base station) according to the present invention receives a request for establishing a TCP connection to a contents server from a wireless LAN client(s) belonging (i.e. being subordinate)s to the wireless LAN access point device, the wireless LAN access point device temporarily terminates the request for establishing the TCP connection requested from the wireless LAN client(s) at the wireless LAN access point device, and the wireless LAN access point device separately establishes a TCP connection between the own device (i.e. wireless LAN access point device) and the contents server, thereby starting a session.

With the above-mentioned arrangement, a segment in a transport layer in which a retransmission request may occur can be divided into a segment, so that transmission/reception control can be performed in each segment. Further, by using W-TCP optimized for wireless communication as TCP parameters between the own device (wireless LAN access point device) and the contents server, the throughput of the wireless LAN access point device in a segment for a mobile communication network and an IP (Internet Protocol) network in FIG. 1 is improved.

### First Exemplary Embodiment

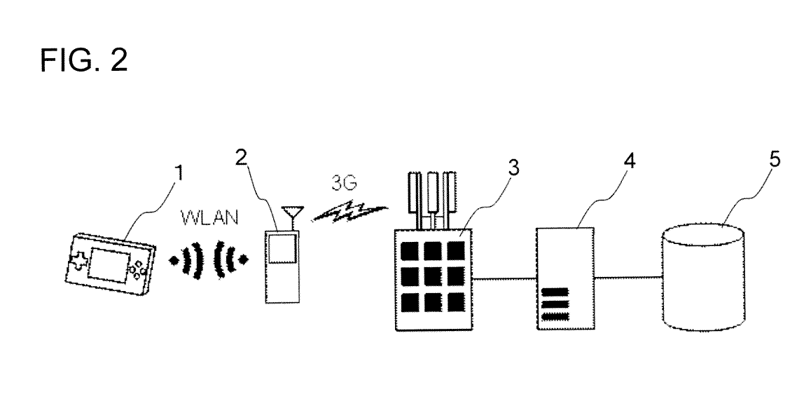

Next, a first exemplary embodiment of the present invention will be described in detail with reference to drawings. FIG. 2 is a diagram for explaining a schematic configuration of the first exemplary embodiment of the present invention. Referring to FIG. 2, there are shown a wireless LAN client 1, a mobile communication terminal 2, a base station 3 on a mobile communication network, a gateway server 4 on the mobile communication network, and a contents server 5 placed on an IP network.

The wireless LAN client 1 is subordinate (i.e. in an accessing state) to a wireless LAN access point, and is an apparatus such as personal computer, game apparatus, camera, or PDA (Personal Digital Assistant) that includes a function of transmitting or receiving data to or from an arbitrary server or the like on a network.

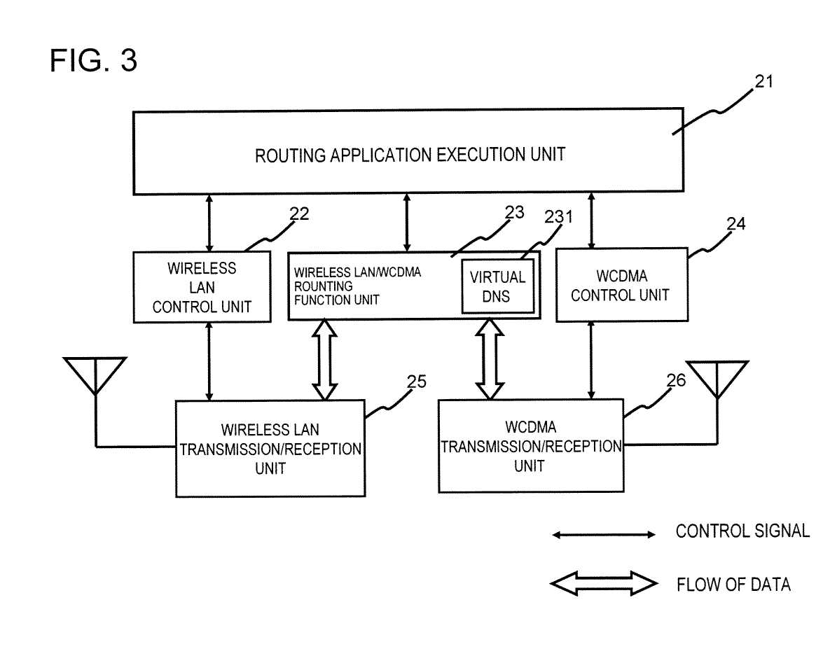

The mobile communication terminal 2 is a cellular phone terminal including a wireless LAN access point function or an access point device or the like configured so that the access point device can be used at an arbitrary location such as outside the home, using the mobile communication network. A detailed configuration of the mobile communication terminal 2 will be described later in detail, using FIG. 3.

The mobile communication terminal 2 can be connected to the IP network through the base station 3 and the gateway server 4 on the mobile communication network.

The contents server 5 is a server for holding contents for the specific wireless LAN client 1, for example.

FIG. 3 is a block diagram showing a configuration of the mobile communication terminal according to the first exemplary embodiment of the present invention. Referring to FIG. 3, there is shown the configuration including a routing application execution unit 21, a wireless LAN control unit 22, a wireless LAN/WCDMA routing function unit 23, a WCDMA (Wideband Code Division Multiple Access) control unit 24, a wireless LAN transmission/reception unit 25, and a WCDMA transmission/reception unit 26.

The routing application execution unit 21 controls respective units of the mobile communication terminal 2, thereby causing the mobile communication terminal 2 to function as the wireless LAN access point. This can be implemented by causing a CPU (Central Processing Unit) mounted on the mobile communication terminal 2 to execute a program for executing a process that will be described later, for example.

According to an instruction from the routing application execution unit 21, the wireless LAN control unit 22 controls the wireless LAN transmission/reception unit 25 compliant with a standard such as IEEE 802.11b/g to execute a subordination process for the wireless LAN client 1 and data transmission/reception including retransmission control.

According to an instruction from the routing application execution unit 21, the WCDMA control unit 24 controls the WCDMA transmission/reception unit 26 connected to the mobile communication network to execute data transmission/reception including retransmission control.

The wireless LAN/WCDMA routing function unit 23 includes a private DNS (Domain Name Server) unit 231 that selects and supplies a virtual IP address (private IP address) for the wireless LAN client(s) 1 from among wireless LAN slave unit virtual IP addresses set in advance, for a name resolution request from the wireless LAN client 1, and associates and stores a domain requested from the wireless LAN client 1 and the supplied virtual IP address.

When the wireless LAN/WCDMA routing function unit 23 receives from the wireless LAN client 1 a request for establishing a TCP connection (SYN) using the virtual IP address as a destination, the wireless LAN/WCDMA routing function unit 23 establishes a TCP connection using a real IP address corresponding to the drain requested from the wireless LAN client 1 as a destination, in place of the wireless LAN client 1. When the TCP connection using the real IP address as the destination, requested from the wireless LAN client 1 is established, the wireless LAN/WCDMA routing function unit 23 sends to the wireless LAN client 1 a response for establishing the TCP connection for the virtual IP address that has been selected and supplied.

When the wireless LAN/WCDMA routing function unit 23 establishes the TCP connection with the connection request destination in place of the wireless LAN client 1, the wireless LAN/WCDMA routing function unit 23 can be made to optimize TCP parameters and perform protocol conversion.

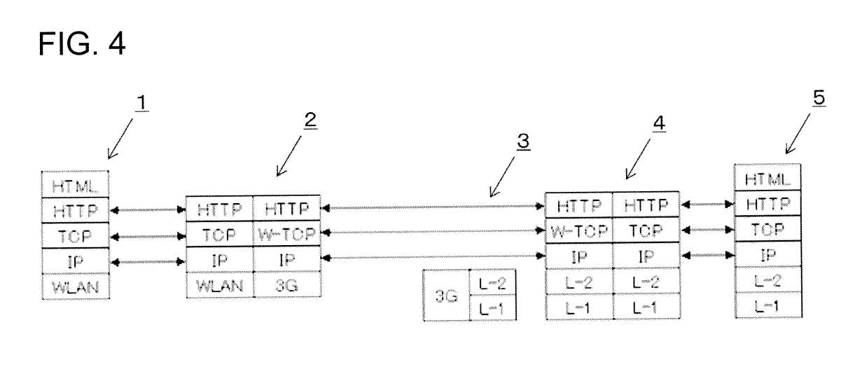

FIG. 4 is a diagram showing a protocol stack when the wireless LAN client 1 in FIG. 2 is accessing the contents server 5. In the example in FIG. 4, communication is performed between the wireless LAN client 1 and the mobile communication terminal 2 in FIG. 4 using TCP, and communication is performed between the mobile communication terminal 2 and the gateway server 4 in FIG. 4 using W-TCP, by the wireless LAN/WCDMA routing function unit 23.

Next, operations of this exemplary embodiment will be described in detail with reference to drawings. First, operations until when the wireless LAN client 1 becomes subordinate to the mobile communication terminal 2 that operates as the access point.

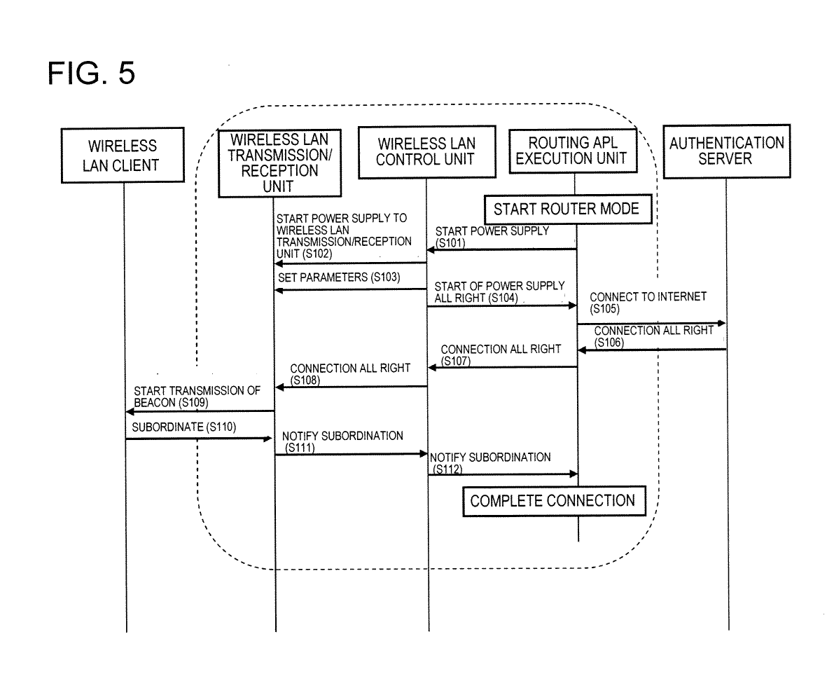

FIG. 5 is a sequence diagram showing the operations until when the wireless LAN client 1 becomes subordinate to the mobile communication terminal 2. Referring to FIG. 5, when a user of the mobile communication terminal 2 starts the routing application execution unit 21 (router mode) through a function selection screen or the like of the mobile communication terminal, the routing application execution unit 21 instructs the wireless LAN control unit 22 to start power supply (in step S10)).

The wireless LAN control unit 22 which has received the instruction starts the power supply to the wireless LAN transmission/reception unit 25 (in step S102), and also sets various wireless LAN parameters (in step S103).

The wireless LAN control unit 22 which has completed the power supply to the wireless LAN transmission/reception unit 25 and setting of the parameters responds that the start of the power supply has been completed (start of the power supply has been all right) to the routing application execution unit 21 (in step S104).

The routing application execution unit 21 that has received the response accesses an authentication server, thereby executing an Internet connection process (in step S105). When Internet connection is completed (in step S106), the routing application execution unit 21 causes the wireless LAN transmission/reception unit 25 to start transmission of a beacon through the wireless LAN control unit 22 (in steps S107 to S109).

When the wireless LAN client 1 receives the beacon and the subordination process is executed (in step S110), notification of subordination is supplied to the routing application execution unit 21 through the wireless LAN transmission/reception unit 25 and the wireless LAN control unit 22, thereby completing connection.

Next, a description will be directed to operations when the wireless LAN client 1 that completed the subordination process has accessed the contents server 5.

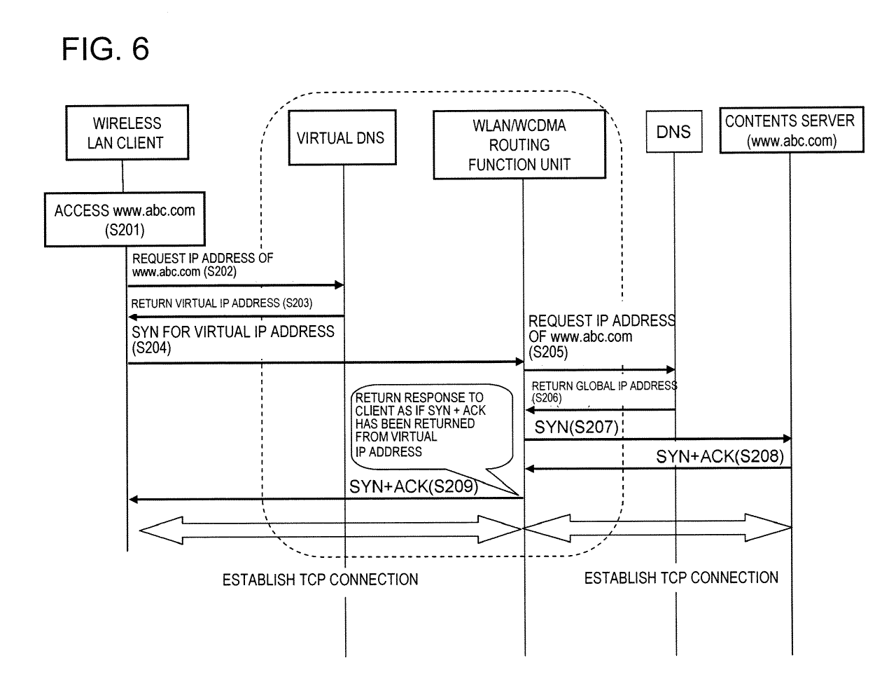

FIG. 6 is a sequence diagram showing the operations until when a TCP connection is established between the wireless LAN client 1 and the contents server 5. In the following description, it is assumed that a domain name of www.abc.com is given to the contents server 5. Then, the user of the wireless LAN client 1 tries to receive contents from www.abc.com.

Referring to FIG. 6, when a request for accessing www.abc.com is first sent from the wireless LAN client 1 (in step S201), the private DNS unit 231 of the mobile communication terminal 2 returns a virtual IP address for the wireless LAN slave unit (in step S203) for a name resolution request for www.abc.com (in step S202). It is assumed that 1.1.1.1 has been responded as the virtual IP address.

The wireless LAN client 1 sends a request for establishing a TC connection (SYN) using the virtual IP address (1. 1. 1. 1) as a destination (in step S204). The wireless LAN/WCDMA routing function unit 23 of the mobile communication terminal 2 that has received the TCP connection establishment request (SYN) inquires the private DNS unit 231 about the domain name based on which the virtual IP address (1.1.1.1) has been issued (selected and supplied), thereby determining that the request for accessing www.abc.com has been made.

The wireless LAN/WCDMA routing function unit 23 of the mobile communication terminal 2 obtains the global IP address of www.abc.com for which the virtual IP address (1.1.1.1) has been selected and supplied (in steps S205 and 9206) from a DNS on the Internet, and then sends a request for establishing a TCP connection (SYN) using the global IP address as a destination (in step S207).

When the wireless LAN/WCDMA routing function unit 23 of the mobile communication terminal 2 receives a response (SYN+ACK) of acknowledging establishment of the TCP connection from the contents server 5 that has received the TCP connection establishment request (SYN) (in step S208), the wireless LAN/WCDMA routing function unit 23 of the mobile communication terminal 2 returns the response of acknowledging TCP connection establishment for the virtual IP address (1.1.1.1) to the wireless LAN client 1 (in step S209).

With the above arrangement, TCP sessions are respectively established between the wireless LAN client 1 and the mobile communication terminal 2 and between the mobile communication terminal 2 and the contents server 5 (to be exact, the gateway server 4).

Thereafter, similarly, when the wireless LAN client 1 transmits a packet to the virtual IP address (1.1.1.1), the mobile communication terminal 2 transmits the packet to the contents server 5. Then when the mobile communication terminal 2 receives any response or the like from the contents server 5, the mobile communication terminal 2 returns the response for the virtual IP address (1.1.1.1) to the wireless LAN client 1.

Accordingly, as seen from the wireless LAN client 1, it becomes possible for the wireless LAN client 1 to perform data transmission/reception with the contents server 5 as if the TCP connection is directly established between the wireless LAN client 1 and the contents server 5.

As described above, this exemplary embodiment is configured so that, when the wireless LAN client 1 performs communication with the contents server 5, the TCP connection is terminated at the cellular telephone terminal 2, and communication is separately performed with the gateway server 4 by the W-TCP optimized for the mobile communication network. Thus, the effective throughput can be improved.

Further, in this exemplary embodiment, the cellular telephone terminal 2 is configured to include the private DNS unit 231 to perform conversion between the virtual IP address and the real address (global IP address). Thus, it becomes possible to provide an environment in which a plurality of wireless LAN clients are simultaneously connected.

Though the above description was given about the exemplary embodiment of the present invention, the present invention is not limited to the above-mentioned exemplary embodiment. Further variation, substitution, and adjustment can be added within the scope not departing from the basic technical concept of the present invention. The description was given, assuming that the WCDMA control unit 24 and the WCDMA transmission/reception unit 26 are included, for example. The present invention can be similarly applied to other wireless communication systems as well.

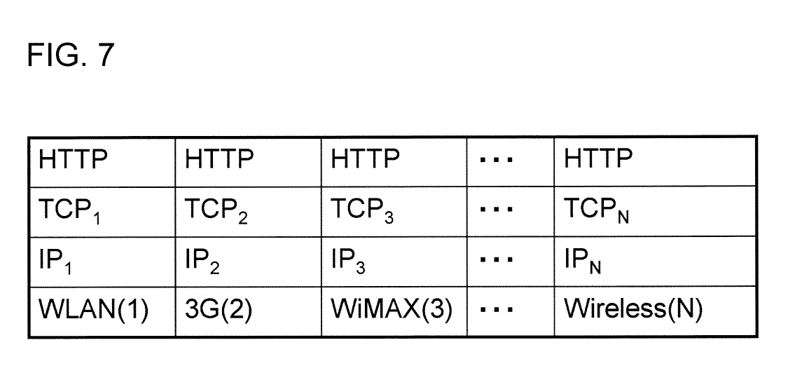

In the above-mentioned exemplary embodiment, the description was given, assuming that the mobile communication terminal 2 includes the wireless LAN transmission/reception unit 25 and the WCDMA transmission/reception unit 26. However, assume that N kinds of communication modules such as a communication module for WiMaX (compliant with IEEE802.16e) is provided at the mobile communication terminal 2, as shown in FIG. 7, for example. Then, also when these communication modules are used, similarly, a TCP connection is temporarily terminated, and a TCP connection can be separately established with an access destination. With this arrangement, a change in parameters of a transport layer protocol such as the TCP can be performed, or the transport layer protocol can be converted, according to each communication module or each wireless segment. The communication throughput can be thereby improved.

When the mobile communication terminal is a portable terminal including a function of acquiring position information by GPS (Global Positioning System) or position information on an in-zone cell, not only an access point function can be provided to the wireless LAN client, but also the position information can be provided to the wireless LAN client and the connection destination server of the portable terminal. To take an example, when a digital camera including a wireless LAN function uploads image data, position information can be added to the image data. Further, to take an example, the mobile communication terminal can function as an access point to cause a game apparatus including the wireless LAN function to participate in an on-line match-up, and information on the position of the wireless LAN client can also be provided as user information on the game. Further, position information can also be provided to a server that provides to the wireless LAN client map information around the wireless LAN client and/or a navigation function.

Modifications and adjustments of the exemplary embodiments and an example are possible within the scope of the overall disclosure (including claims) of the present invention, and based on the basic technical concept of the invention. Various combinations and selections of various disclosed elements are possible within the scope of the claims of the present invention. That is, the present invention of course includes various variations and modifications that could be made by those skilled in the art according to the overall disclosure including the claims and the technical concept.

### EXPLANATIONS OF SYMBOLS

1 wireless LAN client
2 mobile communication terminal
3 base station
4 gateway server
5 contents server
21 routing application execution unit (routing APL execution unit)
22 wireless LAN control unit
23 wireless LAN/WCDMA routing function unit
24 WCDMA control unit
25 wireless LAN transmission/reception unit
26 WCDMA transmission/reception unit
231 private DNS unit

What is claimed is:

1. A wireless LAN access point device, wherein when the wireless LAN access point device receives from a wireless LAN (Local Area Network) client(s) being subordinate to the wireless LAN access point device a request for connection to a predetermined server, the wireless LAN access point device respectively establishes separate communication connections with a side of the wireless LAN client(s) and with a side of the predetermined server, and performs transmission/reception control over data to be transmitted to and received from the wireless LAN client(s) and the predetermined server.

2. The wireless LAN access point device according to claim 1, wherein the wireless LAN access point device comprises:
a private DNS (Domain Name Server) unit that issues a virtual IP Protocol) address for a domain name requested from the wireless LAN client; and
the wireless LAN access point device performs packet routing for the wireless LAN client, using the virtual IP address.

3. The wireless LAN access point device according to claim 1, wherein
the wireless LAN access point device performs a change in parameters of a transport layer protocol or converts the transport layer protocol, according to a communication system of the predetermined server.

4. The wireless LAN access point device according claim 1, wherein the transport layer protocol used for communication with the predetermined server comprises W-TCP (Wireless Profiled Transmission Control Protocol).

5. The wireless LAN access point device according claim 1, wherein the wireless LAN access point device further comprises:
a position information acquisition unit that acquires position information on the wireless LAN access point device; and
the wireless LAN access point device provides the position information acquired by the position information acquisition unit to the predetermined server or the wireless LAN client(s) being subordinate to the wireless LAN access point device.

6. A mobile communication terminal, wherein the mobile communication terminal includes a wireless LAN (Local Area Network) access point function; and
when the mobile communication terminal receives from a wireless LAN client(s) being subordinate to the mobile communication terminal a request for connection to a predetermined server, the mobile communication terminal respectively establishes separate communication connections with a side of the wireless LAN client(s) and with a side of the predetermined sever, and performs transmission/reception control over data to be transmitted to and received from the wireless LAN client(s) and the predetermined server.

7. The mobile communication terminal according to claim 6, wherein the mobile communication terminal comprises:
a private DNS (Domain Name Server) unit that issues a virtual IP (Internet Protocol) address for a domain name requested from the wireless LAN client; and
the mobile communication terminal performs packet routing for the wireless LAN client, using the virtual IP address.

8. The mobile communication terminal according to claim 6, wherein the mobile communication terminal performs a change in parameters of a transport layer protocol or converts the transport layer protocol, according to a communication system of the predetermined server.

9. The mobile communication terminal according claim 6, wherein the transport layer protocol used for communication with the predetermined server comprises W-TCP (Wireless Profiled Transmission Control Protocol).

10. The mobile communication terminal according to claim 6, wherein the mobile communication terminal further comprises:
a position information acquisition unit that acquires position information on the mobile communication terminal; and
the mobile communication terminal provides the position information acquired by the position information acquisition unit to the predetermined server or the wireless LAN client being subordinate to the mobile communication terminal.

11. A communication method comprising:
respectively establishing separate communication connections with a side of a wireless LAN client(s) being subordinate to the mobile communication terminal and with a side of a predetermined server when the mobile communication terminal receives from the wireless LAN client(s) a request for connection to the predetermined server, the mobile communication terminal including a wireless LAN (Local Area Network) access point function to operate as a wireless LAN access point; and
performing transmission/reception control over data to be transmitted to and received from the wireless LAN client(s) and the predetermined server.

12. A computer program for a computer mounted on a mobile communication terminal that includes a wireless LAN (Local Area Network) access point function to operate as a wireless LAN access point, the program causing the computer to execute the processes of:
respectively establishing separate communication connections with a side of a wireless LAN client(s) being subordinate to the mobile communication terminal and with a side of a predetermined server when the mobile communication terminal receives from the wireless LAN client(s) a request for connection to the predetermined server; and
performing transmission/reception control over data to be transmitted to and received from the wireless LAN client(s) and the predetermined server.

13. The wireless LAN access point device according to claim 2, wherein
the wireless LAN access point device performs conversion between the virtual IP address and a global IP address, thereby providing to a plurality of wireless LAN clients an environment in which the wireless LAN clients are simultaneously connected to an identical global IP address.

14. The mobile communication terminal according to claim 7, wherein
the mobile communication terminal performs conversion between the virtual IP address and a global IP address, thereby providing to a plurality of wireless LAN clients an environment in which the wireless LAN clients are simultaneously connected to an identical global IP address.

15. The wireless LAN access point device according to claim 2, wherein
the wireless LAN access point device performs a change in parameters of a transport layer protocol or converts the transport layer protocol, according to a communication system of the predetermined server.

16. The wireless LAN access point device according to claim 2, wherein the transport layer protocol used for communication with the predetermined server comprises W-TCP (Wireless Profiled Transmission Control Protocol).

17. The wireless LAN access point device according to claim 3, wherein the transport layer protocol used for communication with the predetermined server comprises W-TCP (Wireless Profiled Transmission Control Protocol).

18. The wireless LAN access point device according to claim 2, wherein the wireless LAN access point device further comprises:
a position information acquisition unit that acquires position information on the wireless LAN access point device; and
the wireless LAN access point device provides the position information acquired by the position information acquisition unit to the predetermined server or the wireless LAN client(s) being subordinate to the wireless LAN access point device.

19. The wireless LAN access point device according to claim 3, wherein the wireless LAN access point device further comprises:
a position information acquisition unit that acquires position information on the wireless LAN access point device; and
the wireless LAN access point device provides the position information acquired by the position information acquisition unit to the predetermined server or the wireless LAN client(s) being subordinate to the wireless LAN access point device.

20. The wireless LAN access point device according to claim 4, wherein the wireless LAN access point device further comprises:
a position information acquisition unit that acquires position information on the wireless LAN access point device; and
the wireless LAN access point device provides the position information acquired by the position information acquisition unit to the predetermined server or the wireless LAN client(s) being subordinate to the wireless LAN access point device.
